(19) United States
(12) Patent Application Publication
(10) Pub. No.: US 2021/0339479 A1
(43) Pub. Date: Nov. 4, 2021

(54) 3D PRINTING SUPPORT, CONSTRUCTING METHODS, AND PRINTING METHODS THEREOF

(71) Applicant: LUXCREO (BEIJING) INC., Beijing (CN)

(72) Inventors: Guang ZHU, Ningbo (CN); Wen FAN, Ningbo (CN); Haiyong SHI, Beijing (CN)

(73) Assignee: LUXCREO (BEIJING) INC., Beijing (CN)

(21) Appl. No.: 17/239,670

(22) Filed: Apr. 25, 2021

(30) Foreign Application Priority Data
Apr. 29, 2020 (CN) 202010354166.9

(51) Int. Cl. B29C 64/40; B33Y 10/00; B33Y 40/00; B29C 64/393; B33Y 50/02

(52) U.S. Cl. CPC B29C 64/40; B33Y 10/00; B33Y 50/02; B29C 64/393; B33Y 40/00

(57) ABSTRACT

The present disclosure is related to a support of a three-dimensional (3D) printed object. The support may include a main body and a connection component connected to the 3D printed object. At least one end of the support may be connected to the 3D printed object. A surface of the 3D printed object may be provided with a concave part. The connection component of the support may be connected to the concave part.

### CROSS-REFERENCE TO RELATED APPLICATIONS

This application claims priority of Chinese Patent Application No. 202010354166.9, filed on Apr. 29, 2020, the contents of which are hereby incorporated by reference.

### TECHNICAL FIELD

The present disclosure relates to the field of three-dimensional (3D) printing, and more particular, relates to a 3D printing support that eliminates the need for polishing a printed object during a post-processing process, and constructing methods and printing methods thereof.

### BACKGROUND

A technical principle of 3D printing is to divide a 3D model into a plurality of layers, obtain contour information or image information of each layer of the plurality of layers, and print layer by layer using a powdered metal, a resin or other adhesive material to complete the printing of a printed object.

Light curing 3D printing is a type of 3D printing. In the light curing 3D printing, the photosensitive resin is cured layer by layer via the light radiation, and superimposed layer by layer. In principle, an upper structure of a model is generally required to be supported by a lower structure of the model. Therefore, if a certain part of a printed object is suspended, it is usually necessary to design a support to support the suspended part of the printed object.

When the 3D model is layered, each slice layer has a certain thickness. Contour information of a slice layer at a connection part between the support and the printed object may include a “corner” formed by the support and the printed object. Since each slice layer has a relatively small thickness (e.g., about 0.05 mm-0.2mm), and a certain amount of refraction may occur when the light radiation is irradiated to the photosensitive resin. During the 3D printing process, the photosensitive resin may appear an “excessive curing” phenomenon in the corner contour of the connection part between the support and the printed object. As shown in FIG. 1, the connection part between a support 10 and a printed object 20 may have a convex part formed due to an excess curing component 30. After the printing is completed, the support 10 may be removed, and a surface of the printed object 20 may need to be polished to remove the convex part formed due to the excess curing component 30.

### SUMMARY

The technical problem to be solved by the present disclosure is that, by providing a concave part on a surface of a 3D model of a printed object, and a connection component of a support that is connected to the printed object is connected to the concave part, in the 3D printing process, an excess curing component generated at a connection part between the support and the printed object may be filled in the concave part. After the 3D printing is completed, the support and the printed object may be separated directly, and there is generally no residual material or damage at the connection part between the support and the printed object after the separation. A polishing post-processing operation of the printed object may be omitted, and a 3D printing method without polishing may be realized.

In one aspect of the present disclosure, a support of a 3D printed object may be provided. The support may include a main body and a connection component connected to the 3D printed object. At least one end of the support may be connected to the 3D printed object. A surface of the 3D printed object may be provided with a concave part, and the connection component of the support may be connected to the concave part.

In some embodiments, the concave part on the surface of the 3D printed object may be connected to the connection component.

In some embodiments, a center of the concave part may be a deepest point of the concave part.

In some embodiments, an axial direction of the connection component of the support may be substantially perpendicular to a tangent plane at a bottom of the concave part.

In some embodiments, the concave part may have a symmetrical structure.

In some embodiments, the concave part may have at least one of a hemisphere structure, a semi-ellipsoid structure, a cone structure, or a circular truncated cone structure.

In some embodiments, a chamfer may be provided on an edge of the support where the concave part is connected to the surface of the 3D printed object.

In some embodiments, an angle of the chamfer may be 45°.

In some embodiments, the chamfer may be a circular chamfer.

In some embodiments, the concave part may have a hemisphere structure. A radius of the circular chamfer may be less than or equal to a radius of the hemisphere structure of the concave part.

In some embodiments, a cross-sectional area of a connection part between the main body and the connection component may be larger than a cross-sectional area of a connection part between the connection component and the 3D printed object.

In some embodiments, at least one of a volume or a depth of the concave part may be variable.

In some embodiments, a larger cross-sectional area of a connection part between the connection component of the support and the 3D printed object may correspond to a larger volume or a greater depth of the concave part.

In some embodiments, the connection component of the support may have a circular truncated cone structure. A first surface of the circular truncated cone structure may be connected to the 3D printed object. A second surface of the circular truncated cone shape may be connected to the main body of the support. An area of the first surface may be less than an area of the second surface.

According to another aspect of the present disclosure, a method for constructing a 3D printed object may be provided. The method may include obtaining a 3D model of the 3D printed object. The method may include determining a connection point for constructing the support on the 3D model. The support may include a main body and a connection component. The method may include providing a concave part centered at the connection point on a surface of the 3D model. The method may include constructing the support by connecting the connection component of the support to the center point of the concave part on the surface of the 3D model.

According to another aspect of the present disclosure, a 3D printing method may be provided. The 3D printing method may include processing a 3D model of a 3D printed object. The 3D printing method may include preparing a 3D printing material. The 3D printing method may include 3D printing the processed 3D model of the 3D printed object using the 3D printing material.

In some embodiments, the processing the 3D model of the 3D printed object may include: obtaining the 3D model of the 3D printed object; determining a connection point for constructing a support on the 3D model, the support may include a main body and a connection component; providing a concave part centered at the connection point on a surface of the 3D model; and constructing the support by connecting the connection component of the support to the center point of the concave part on the surface of the 3D model.

In some embodiments, at least one of a volume or a depth of the concave part may be variable.

In some embodiments, a larger viscosity of the 3D printing material may correspond to a larger volume or a greater depth of the concave part.

In some embodiments, after the 3D printing is completed, the 3D printing method may further include separating the support and the 3D printed object. A surface of a connection part between the support and the 3D printed object may be smooth.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating a structure of a printed object and a structure of a support in prior arts;

FIG. 2 is a schematic diagram illustrating a printed object and a support according to some embodiments of the present disclosure;

FIG. 3 is a schematic diagram illustrating a concave part on a surface of a printed object according to some embodiments of the present disclosure; and

FIG. 4 is a schematic diagram illustrating a connection between a printed object and a support in a 3D model and a connection between the printed object and the support after a 3D printing process according to some embodiments of the present disclosure. In FIG. 4, 10 indicate a support, 11 indicate a main body, 12 indicate a connection component, 20 indicate a printed object, 21 indicate a concave part, 22 indicate a chamfer, and 30 indicate an excess curing component.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Also, the term “exemplary” is intended to refer to an example or illustration.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention.

Spatial and functional relationships between elements (for example, between layers) are described using various terms, including “connected,” “engaged,” “interfaced,” and “coupled.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

Spatial related terms, such as “below,” “lower,” “lower part,” “above,” “upper part”, etc., are used herein to describe relationship between elements or components shown in the drawings and one or more other elements or components. It should be understood that, in addition to the orientation depicted in the drawings, the spatially related terms are also intended to include different orientations of the device in use or operation. For example, if a device in the drawings is reversed, elements described as “below” or “beneath” other elements or components will be oriented “above” the other elements or components. Thus, the exemplary term “below” can include both an orientation of above and below. The device can be oriented in other ways (rotated by 90 degrees or other orientations) and correspondingly interpret the spatially related descriptors used herein. Similarly, unless explicitly indicated otherwise, the terms “upward,” “downward,” “vertical,” “horizontal,” etc. are used herein for explanation only.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Some embodiments of the present disclosure relate to a support of a 3D printed object. The support may be applied to a plurality of scenes for printing a 3D printed object. For example, the support may be applied to a 3D printing technique such as a light curing molding, a fused deposition rapid prototyping, or a 3D powder bonding molding. In some embodiments, the support may be a support in a 3D printing design process, a support in a printing process, or a support after the printing process is completed. The present disclosure also relates to a printed object that use the support when printing. The printed object may be a hollow printed object used in various aspects such as medical, industrial, life, and art. The present disclosure also relates to a method for constructing a support of a 3D printed object and a 3D printing method. Those skilled in the art can use the method for constructing the support to construct a support of a printed object on softwares such as Rhino, SolidWorks, Catia, UG, etc, and complete the printing process by various 3D printing devices. This disclosure does not limit the application scenarios of the support of the 3D printed object, the 3D printed object, the method for constructing the support of the 3D printed object, and the 3D printing method.

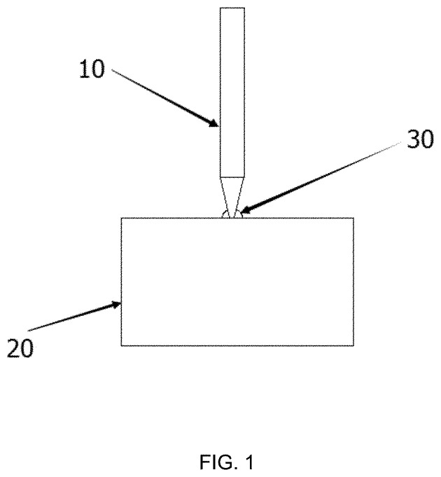

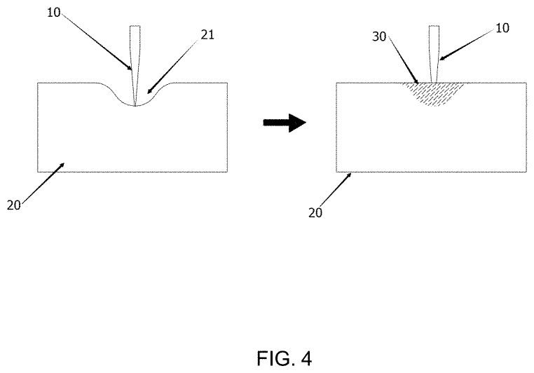

As shown in FIGS. 1-4, a support 10 disclosed in the present disclosure may include a main body 11 and a connection component 12 connected to a printed object 20. A surface of the printed object 20 may be provided with a concave part 21. The connection component 12 of the support 10 may be connected to a center of the concave part 21. In some embodiments of the present disclosure, the concave part 21 provided on the surface of the printed object 20 may not be an original surface profile of the printed object 20, and may be a new concave part 21 opened on the original surface of the printed object 20 to cooperate with the support 10. After the 3D printing is completed, the concave part 21 may be filled with an excess curing component 30 generated during a curing process. It should be noted that the connection component 12 of the support 10 may be connected to the printed object 20. That is, at least one end of the support 10 may be connected to the printed object 20. For example, one end of the support 10 may be connected to a molding station of a 3D printing device, and the other end of the support 10 may be connected to the printed object 20. The molding station may be configured to support the printed object 20 in the printing process. As another example, the two ends of the support 10 may be connected to the printed object 20.

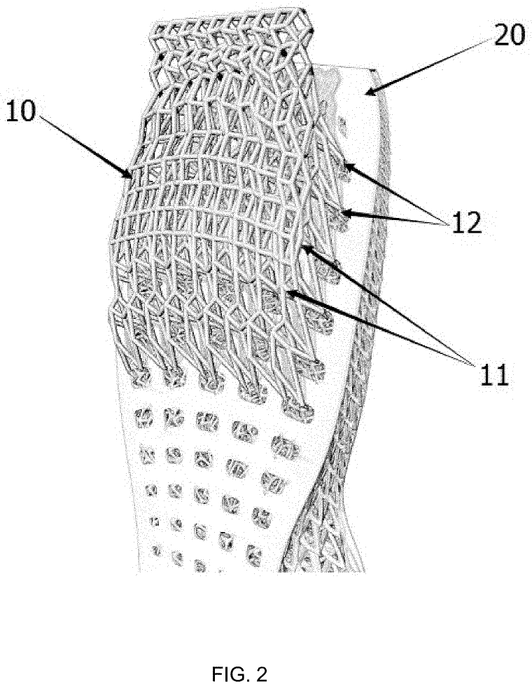

The following is a description of the structure of the concave part 21. In some embodiments, one concave part 21 on the surface of the printed object 20 may be connected to one connection component 12. That is, each support 10 may be connected to a corresponding concave part 21. As shown in FIG. 2, the main bodies 11 of adjacent supports 10 may be connected to each other, and have a mesh structure. The connection component 12 may independently extend out of the mesh structure and be connected to the printed object 20.

In some embodiments, a center of the concave part 21 may be a deepest point of the concave part 21. That is, the connection component 12 of the support may extend to the deepest point of the concave part 21, and be connected to the printed object 20. In some embodiments, an axial direction of the connection component 12 of the support 10 may be (substantially) perpendicular to a tangent plane at a bottom of the connected concave part 21. In some embodiments, the concave part 21 may have a symmetrical structure. For example, the concave part 21 may have a hemispheric structure, a semi-ellipsoid structure, a cone structure, a circular truncated cone structure, or the like. In this way, when the excess curing component 30 is generated during the 3D printing process, the concave part 21 may be filled more uniformly to complete the printing process. After the printed object 20 is separated from the support 10, the surface of the printed object 20 may be smooth, and there is no need to polish the printed object 20 in the post-processing process.

In some embodiments, a depth of the concave part 21 may be between 0.1 mm and 0.5 mm. If the concave part 21 is provided on a relatively wide surface of the printed object 20 (e.g., a width of the surface of the printed object 20 is greater than a diameter of the concave part 21), the concave part 21 may be a complete symmetrical structure, such as a hemisphere structure, a semi-ellipsoid structure, a cone structure, a circular truncated cone structure, or the like. In this situation, an opening area of the concave part 21 on the surface of the printed object 20 may be between 0.03 mm² and 0.8 mm².

In some embodiments, if the concave part 21 is provided on a relatively narrow surface of the printed object 20 (e.g., the width of the surface of the printed object 20 is smaller than the diameter of the concave part 21). A preset concave part 21 may be provided on the surface of a 3D model of the printed object 20. The center of the concave part 21 may coincide with a center of a preset area. Even if the concave part 21 is not complete on the printed object 20, it should be ensured that the concave part 21 has a symmetrical structure on the printed object 20 as much as possible. It may be beneficial for the concave part 21 to be filled more uniformly when the excess curing component 30 is generated during the 3D printing process.

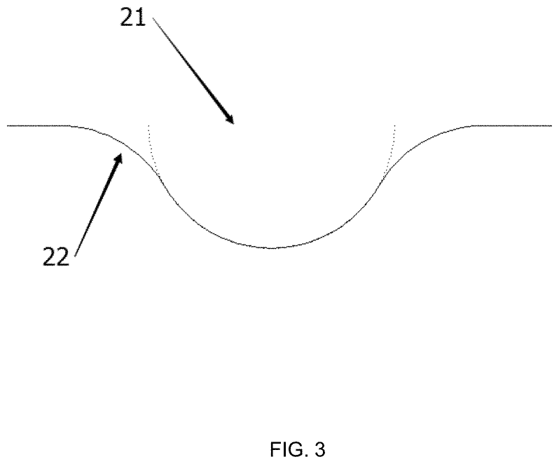

Since a traditional edge design of the concave part 21 can cause a transition (i.e., an edge of the concave part 21) between the concave part 21 and the surface of the printed object 20 has a corner angle, and an additional convex part may be generated after the excess curing component 30 is filled in the concave part 21. After the support 10 is separated from the printed object 20, the filling of the concave part 21 of the 3D printed object caused by the excess curing component 30 may not be smooth. In some embodiments, as shown in FIG. 3, a chamfer 22 may be provided on an edge of the concave part 21. The chamfer 22 may be provide to optimize the local excess curing component 30 at the edge. For example, a circular chamfer may be provided on the concave part 21, which may make the transition between the edge of the concave part 21 and the surface of the printed object 20 more smooth. By providing the chamfer, after the support 10 is separated from the printed object 20, the filling of concave part 21 of the printed object caused by the excess curing component 30 may be more smooth.

The following is a description of a preferred embodiment of the structure of the concave part 21. As shown in FIG. 3, the concave part 21 may have a hemisphere structure. A circular chamfer of 45° may be provided on an edge of the concave part 21. The concave part 21 may have a hemisphere structure. A radius of the circular chamfer may be equal to a radius of the hemisphere structure of the concave part. It should be noted that the radius of the circular chamfer and the radius of the concave part 21 may be adjusted according to an actual printing demand. The preferred embodiment is that the radius of the circular chamfer is less than or equal to the radius of the hemisphere structure. A volume and a depth of the concave part 21 may be variable. A larger cross-sectional area of a connection part between the connection component 12 of the support 10 and the printed object 20 may correspond to a larger volume and/or a greater depth of the concave part 21.

The following is a description of the structure of the support 10. According to the actual printing demand, the structure of the support 10 may be adjusted according to the change of the structure of the printed object 20. In some embodiments, the construction of the structure of the support 10 may be automatically completed by a software algorithm (e.g., grasshopper). The construction of the structure of the support 10 may also be designed and adjusted manually. In some embodiments, the support 10 may include a columnar support, a sheet support, a mesh support, or the like, or any combination thereof. Those skilled in the art may determine the structure of the support 10 according to actual needs in an actual operation process, which is not limited in this disclosure. In some embodiments, the support 10 may include a sheet support. The sheet support may include one flat surface, or a plurality of flat surface that are not parallel to each other, or one or more curved surfaces. The thickness of the sheet support may be between 0.1 mm and 10 mm.

In some embodiments, the cross-sectional area of the connection component 12 may be equal to the cross-sectional area of the main body 11. In some embodiments, the cross-sectional area of one end of the connection component 12 connected to the printed object 20 may be smaller than the cross-sectional area of the main body 11. Specifically, the connection component 12 may be connected between the main body 11 and the printed object 20. The main body 11 may be used to support the printed object 20. The main body 11 may not be connected to the printed object 20, and the connection component 12 may connect the main body 11 and the printed object 20. The setting of the cross-sectional area of the connection component 12 and the cross-sectional area of the main body 11 may ensure that the support 10 can be easily removed from the printed object 20 after the printing process is completed. When the main body 11 has different shapes, those skilled in the art may ensure that the cross-sectional area of one end of the connection component 12 connected to the printed object 20 is smaller than the cross-sectional area of the main body 11 by a variety of design forms. For example, the support 10 may include a columnar support. The main body 11 may include one or more support columns. The connection component 12 may include one or more connection columns connected between the one or more support columns and the printed object 20, respectively. The cross-sectional area of the connection column may be smaller than the cross-sectional area of the support columns. The connection column may have a pyramid structure, a cone structure, a circular truncated structure, or the like. One end of the connection column of the pyramid structure, the cone structure, the circular truncated structure, or the like, with a relatively small cross-sectional area may be connected to the printed object 20, and the other end of the connection column with a relatively large cross-sectional area may be connected to the support column. As another example, the support 10 may include a mesh support. The main body 11 may include a plurality of columns forming a mesh structure. The connection component 12 may include one or more connection columns connected between the plurality of columns and the printed object 20. As shown in FIG. 2, the main body 11 may have a cylinder structure. A plurality of cylinder structures may be connected to each other, and support each other. Specifically, a diameter of the cylinder structure may be between 0.1 mm and 50 mm (e.g., 0.1 mm, 0.5 mm, 1 mm, 5 mm, 10 mm). The cross-sectional area of the connection column may be smaller than the cross-sectional area of the column. The connecting column may have a pyramid structure, a cone structure, a circular truncated cone structure, or the like. One end of the connection column of the pyramid structure, the cone structure, the circular truncated cone structure, or the like, with a relatively small cross-sectional area may be connected to the printed object 20, and the other end of the connection column with a relatively large cross-sectional area may be connected to the column. As still another example, the support 10 may include a sheet support. The main body 11 may include a support sheet. The thickness of the support sheet may be between 0.1 mm and 10 mm. The connection component 12 may include a serrated structure connected between the support sheet and the printed object 20, or a plurality of connection columns arranged at intervals. One end of the connection component 12 of the serrated structure with a relatively small cross-sectional area may be connected to the printed object 20, and the other end of the connection component 12 with a relatively large cross-sectional area may be connected to the support sheet. In some embodiments, the connection component 12 of the sheet support connected to the printed object 20 may include a connection column of a pyramid structure, a cone structure, a circular truncated structure, or the like. One end of the connection column of the pyramid structure, the cone structure, the circular truncated structure, or the like, with a relatively small cross-sectional area may be connected to the printed object 20, and the other end of the connection column with a relatively large cross-sectional area may be connected to the support sheet.

The following is a description of a structural relationship between the support 10 and the concave part 21. According to the actual printing demand, the structure of the support 10 may be adjusted according to the change of the structure of the printed object 20. The structure of the concave part 21 may be adjusted according to the change of the structure of the support 10. In some embodiments, the construction of the structure of the support 10 may be automatically completed by a software algorithm (e.g., grasshopper). The construction of the structure of the support 10 may also be designed and adjusted manually. Specifically, the volume and the depth of the concave part 21 may be adjusted according to the change of the structure of the support 10, in order to ensure that the excess curing component 30 is uniform during the 3D printing process. For example, a larger cross-sectional area of the connection part between the connection component 12 of the support 10 and the printed object 20 may correspond to a larger volume and a greater depth of the concave part 21.

The following is a description of a method for constructing the support 10 of the printed object 20 and a printing method. In an actual operation process, before the 3D printing, the structure of the support 10, the structure of the printed object 20, and the connection manner of the support 10 and the printed object 20 may be implemented on computer softwares (e.g., Rhino, SolidWorks, Catia or UG Software). The method for constructing the support 10 of the printed object 20 may include: obtaining a 3D model of the printed object 20; determining a connection point for constructing the support 10 on the 3D model; providing the concave part 21 centered at the connection point on a surface of the 3D model; and constructing the support 10 by connecting the connection component 12 of the support 10 to the center point of the concave part 21 on the surface of the 3D model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the above-mentioned logical sequence of the computer software algorithm may be a preferred sequence for constructing the support 10 of the 3D model of the printed object 20, and any exchange of this sequence should be included in the scope of the present disclosure.

In some embodiments, the printing method may include: preparing a 3D printing material; 3D printing a processed 3D model of the 3D printed object 20 using the 3D printing material; after the 3D printing is completed, separating the support 10 and the printed object 20. The surface of the connection part between the support 10 and the printed object 20 may be smooth. In some embodiments, the processed 3D model of the 3D printed object 20 may be obtained according to the method for constructing the support 10 of the printed object 20.

Since the 3D printing material of different formulations has different performances, a viscosity of the material may be an important factor in the printing process. The viscosity of the 3D printing material may affect a refractive index and a flow rate of the 3D printing material. In some embodiments, a larger viscosity of the 3D printing material may correspond to a larger volume or a greater depth of the concave part 21.

The possible beneficial effects of the method for constructing the support 10 of the printed object 20 disclosed in the present disclosure may include but are not limited to: (1) After the support 10 is separated from the printed object 20, the residual material of the support 10 may not remain on an outer surface of the printed object 20, so that the appearance and the function of the printed object 20 may not be affected. (2) After the 3D printing process is completed, the support 10 may be separated from the printed object 20 easily. (3) After the support 10 is separated from the printed object 20, the surface of the printed object 20 may be smooth, a post-processing such as a polish processing may be omitted, and the production efficiency may be improved. It should be noted that different embodiments may have different beneficial effects. In different embodiments, the possible beneficial effects may be any of one or a combination of the above, or any other beneficial effects that may be obtained.

It should be noted that the support 10 may be configured to support the printed object 20 in the 3D printing process. After the 3D printing process is completed, the support 10 needs to be removed. The support 10 may not be a part of the printed object 20. Therefore, in the case of satisfying the supporting function, the support 10 needs to be removed as easily as possible. According to some embodiments of the present disclosure, before the 3D printing process, the concave part 21 may be provided on the 3D model of the printed object 20. The support 10 may be connected to the center of the concave part 21. The concave part 21 may be filled with the excess curing component 30 generated during the 3D printing process. After the 3D printing process is completed, there is no “convex” formed at the connection part between the support 10 and the printed object 20, which may facilitate the separation between the support 10 and the printed object 20, and may ensure that there is no residual material after the support 10 is separated from the printed object 20. The embodiments of the present disclosure may be applied for the printed object 20 and the support 10 of all structures.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

What is claimed is:

1. A support of a three-dimensional (3D) printed object, including a main body and a connection component connected to the 3D printed object;
at least one end of the support is connected to the 3D printed object; and
a surface of the 3D printed object is provided with a concave part, and the connection component of the support is connected to the concave part.

2. The support of claim 1, wherein the concave part on the surface of the 3D printed object is connected to the connection component.

3. The support of claim 1, wherein a center of the concave part is a deepest point of the concave part.

4. The support of claim 1, wherein an axial direction of the connection component of the support is substantially perpendicular to a tangent plane at a bottom of the concave part.

5. The support of claim 1, wherein the concave part has a symmetrical structure.

6. The support of claim 1, wherein the concave part has at least one of a hemisphere structure, a semi-ellipsoid structure, a cone structure, or a circular truncated cone structure.

7. The support of claim 1, wherein a chamfer is provided on an edge of the support where the concave part is connected to the surface of the 3D printed object.

8. The support of claim 7, wherein an angle of the chamfer is 45°.

9. The support of claim 7, wherein the chamfer is a circular chamfer.

10. The support of claim 9, wherein the concave part has a hemisphere structure, and a radius of the circular chamfer is less than or equal to a radius of the hemisphere structure of the concave part.

11. The support of claim 1, wherein a cross-sectional area of a connection part between the main body and the connection component is larger than a cross-sectional area of a connection part between the connection component and the 3D printed object.

12. The support of claim 1, wherein at least one of a volume or a depth of the concave part is variable.

13. The support of claim 12, wherein a larger cross-sectional area of a connection part between the connection component of the support and the 3D printed object corresponds to a larger volume or a greater depth of the concave part.

14. The support of claim 1, wherein the connection component of the support has a circular truncated cone structure, a first surface of the circular truncated cone structure is connected to the 3D printed object, a second surface of the circular truncated cone shape is connected to the main body of the support, and an area of the first surface is less than an area of the second surface.

15. A method for constructing a support of a three-dimensional (3D) printed object, comprising:
obtaining a 3D model of the 3D printed object;
determining a connection point for constructing the support on the 3D model, wherein the support includes a main body and a connection component;
providing a concave part centered at the connection point on a surface of the 3D model; and
constructing the support by connecting the connection component of the support to the center point of the concave part on the surface of the 3D model.

16. A three-dimensional (3D) printing method, comprising:
processing a 3D model of a 3D printed object, including:
obtaining the 3D model of the 3D printed object;
determining a connection point for constructing a support on the 3D model, wherein the support includes a main body and a connection component;
providing a concave part centered at the connection point on a surface of the 3D model; and
constructing the support by connecting the connection component of the support to the center point of the concave part on the surface of the 3D model;
preparing a 3D printing material; and
3D printing the processed 3D model of the 3D printed object using the 3D printing material.

17. The method of claim 16, wherein at least one of a volume or a depth of the concave part is variable.

18. The method of claim 17, wherein a larger viscosity of the 3D printing material corresponds to a larger volume or a greater depth of the concave part.

19. The method of claim 16, further comprising:
after the 3D printing is completed, separating the support and the 3D printed object, wherein a surface of a connection part between the support and the 3D printed object is smooth.

20. The method of claim 16, wherein the concave part has a symmetrical structure.
